(19) United States
(12) Patent Application Publication
(10) Pub. No.: US 2006/0226250 A1
(43) Pub. Date: Oct. 12, 2006

(54) Light projecting beverage dispensing device

(76) Inventors: Doug Elliott, Mississauga (CA); Bernard Beasley, London (CA)

Correspondence Address: James W Kerr;Labatt Brewing Company Limited, 303 Richmond Street, London, ON, N6B 2H8, CA

(21) Appl. No.: 10/540,581

(22) PCT Filed: Dec. 22, 2003
(86) PCT No.: PCT/CA03/01997

§ 371 Date: Mar. 16, 2006

(30) Foreign Application Priority Data
Dec. 24, 2002 (CA) 2,415,130

(51) Int. Cl. E03B 9/20; B05B 17/08; F21S 8/00

(52) U.S. Cl. 239/18; 239/16; 239/17

(57) ABSTRACT

A beverage dispensing assemblage or device is provided which includes light emitting means adapted to project light upward so as to highlight a selected portion of the ceiling or other features located above the device. The beam can project unencumbered light or words or images comprising customer information. It allows for simple inexpensive and rapid changes in the message projected.

### FIELD OF THE INVENTION

The present invention relates generally to beverage dispenser units as widely used in retail establishments such as hotels, restaurants, breweries and bars. More particularly, it relates to the use of the devices and associated equipment used to dispense the beverages and to promote the beverages being dispensed. Such units utilize dispensing tap assemblies comprising stanchions and tap handles carrying displays which are decorated, sometimes illuminated, and oriented so as to provide an attractive visual presentation to patrons.

### BACKGROUND OF THE INVENTION

According to Canadian Patent Application 2,268,498, “most beverage dispenser stanchions or towers are of relatively simple construction, and not pleasing to the eye”. It is true that many, if not most stanchions, like those used in the dispense of so-called “draft beer”, are often little more that simple cylindrical metal housings with a beverage dispensing tap attached thereto. Nevertheless, these have the merit of being relatively inexpensive, easy to clean and durable. It might also be noted that many such dispensing devices are affixed to the bar surface between the bar staff and bar patrons and at an elevated location, often at eye level.

Bar and restaurant owners, however, also understand the need to provide their customers with a social experience that goes beyond simple provision of food and drink. These considerations certainly extend to offering visual interest, venue-appropriate on theme décor, and a choice-facilitating display that is indicative of currently available brand selection. In addition, each specific dispensing device is used to advertise and promote the brand of beverage being dispensed therefrom especially since a significant number of patrons upon entering an establishment to purchase a beverage rely on visual indicators to learn what beverages are available to choose from. Obviously, all such presentations are visible from at least one side by seated or standing patrons. Notwithstanding these considerations, the relative merits of the simple housings mentioned above, coupled with the reluctance of the owners to invest in more decorative and expensive stanchions that could become dated or obsolete (e.g. with changes in product graphics, color schemes in the décor, the proffering of brand selection), are significant barriers to the production, purchase and use of decorative beverage dispense stanchions.

Accordingly, there remains a need in the art for inexpensive (from both capital and operating cost perspectives), durable, illuminated beverage stanchions which provide for displays that can be interchanged for many reasons including to meet changes in décor and brand selections or updated graphics. Preferably, the illumination should provide for high luminosity with low heat generation (especially where cold beverages are being dispensed), low energy consumption, and limited non-display “spill-over” of illumination into the ambient environment of the serving establishment. It would also be advantageous, if the illuminated display could be operated to advantage in a setting of diminished ambient lighting such as a “night club” atmosphere.

It is an object of the present invention to provide a dispensing tap assembly with improved promotional capabilities at relatively low cost.

### DESCRIPTION OF INVENTION

The present invention provides a beverage dispensing assembly or device which includes light emitting means adapted to project a beam of light upwardly which beam is adapted to import or communicate information to consumers. This may be by selectively highlighting information displaying means or a feature located above. The feature can be an object, such as a display item, e.g. a mobile spaced from and suspended above the device; a screen and an area of the ceiling could function as such upon which the beam could project information such as words; images; colours; recipes; messages; etc. and in fact, anything which may be of interest to the patrons in the establishment and so on. In this context, the term “light” refers to non-harmful electromagnetic radiation and includes visible light, ultra violet, infra red; etc. In the case of visible light, a simple screen or even an area of the ceiling; or a promotional article such as a cardboard bottle suspended therefrom and so on would be illuminated thereby being brought to the attention of, imported or communicated to, the patrons. In the case of a beam of ultra violet light, the feature may be an ultra violet sensitive area or message on the ceiling; the latter would then become “visible” and be drawn to the attention of patrons.

There can be more than one beam emanating from one emitter or more than one beam each emanating from its own emitter and producing separate illuminated areas or interacting to form one display.

The beam may be projected directly upward i.e. at approximately right angles to the plane of the floor or the bar counter upon which the device is sitting. However, that orientation is not critical and, in fact, it may be desirable for many applications of the present invention to ensure the beam is angled to the vertical to a limited extent. However, it would be undesirable if the beam were angled too far from the vertical since, depending at which height the beam exits its associated emitter, there might be a tendency for it to be directed toward and cause inconvenience, discomfort or unease to patrons, or staff for example by shining in their eyes. “Upwardly” herein therefore means vertical or at an angle thereto such that it does not disturb or otherwise adversely affect a patron or a staff member. It should be noted that, in some embodiments of the present invention, the beam is not stationary; it can move but its' movement is restricted to ensure it meets the above requirements. As a practical matter, the resultant beam or beams will probably be restricted to move only within a cone with the beam source at a point including a vertical axis and where the cone angle is not more than about 60° preferably about 30°. However, this is essentially dependant on the location of the beam base of the beam; the higher from the ground it is located, the greater the angle from the vertical the beam may make without causing the undesirable effects referred to above.

The beam of the visual promotional system according to the invention may be used in a variety of ways for example:
(a) A stationary narrowly focused beam may simply, by way of color selection, project a colored spot on the ceiling. This alone could impact information. For example, if a beer has a brand name of BLUE® then a blue spot projected onto the ceiling would clearly advertise the availability of that brand of beer. Moreover, the beam might be switched on only when the tap is dispensing the product, in essence, importing the information “another “BLUE®” brand of beer is being dispensed”.
(b) Alternatively, a relatively large beam for example in the form of a rectangle or square would, in effect, constitute a “panel” of light on the ceiling size depending also on the distance the beam has to travel to impinge on the ceiling. A message suitably affixed to or otherwise located on the “lens” or window of the light emitter would be highlighted on the panel. Again, that message could be a beer label or other words and/or insignia signifying a brand of beer would provide the same message to the patrons as the color “blue” did for the BLUE® brand of beer. The message could be on transparencies and be readily changeable at very low cost.
(c) The light panel as discussed above could readily be used to display or “run” a changing message. The light emitting means can be a miniature projector adapted to project for example, via a light guide arrangement, its carrier beam upwardly as taught by the present invention. This embodiment might be used to run advertisements, names of available pub fare, even questions such as trivia or “is “name of patron” in the establishment” etc.
(d) The beam may be stationary in a base condition but move in response to a change in that condition. For example, movement of the beverage dispensing tap, can be arranged to cause said beam to move during the dispensing of the beer for example in response to movements of the dispensing tap, which when completed, returns to its base position. In such a system, it could be arranged that the beam directs attention to a message, such as the separate letters “B”; “L”; “U”; and “E” to spell “BLUE®” “I AM POURING A BLUE®” on the ceiling. Moreover, the beam can be arranged to illuminate the words in such phrases in sequence to enhance the presentation of the message.
(e) The system can be enhanced further by using non-visible light such as ultra violet or infrared. In this way, a message; label or other indicia is painted or otherwise applied to the ceiling and it only becomes visible only upon being contacted by, an ultra violet beam.
(f) The beam can be arranged to switch on-and-off in a periodic or random manner. In the former, it would function as a strobe light. The latter might be effected using any of the standard circuits or, simply, use an action taken e.g. movement of the tap to dispense a beverage also to cause the beam to go on/off.
(g) Promotional items such as mobiles above the device e.g. suspended from the ceiling, can be highlighted with visible light either continually or periodically. Parts of the mobile may be coated with paint which responds to ultra violet light and hence be separately highlighted by a separate ultra violet beam.

The present invention will now be described, by way of example only, with reference to the accompanying drawings, in which:

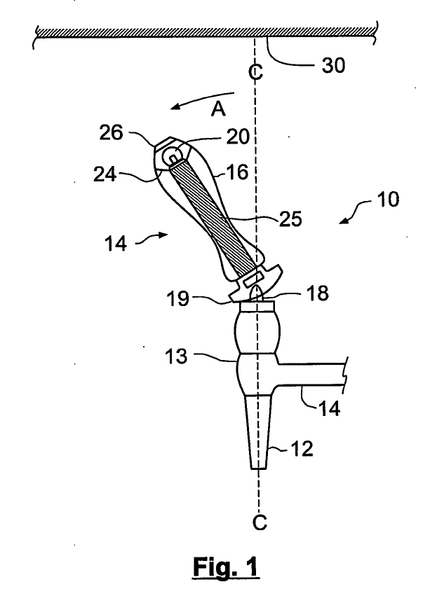

FIG. 1 shows a dispensing tap device (a “pump”) for dispensing beverages such as beer wherein the light emitting means is contained within a tap handle

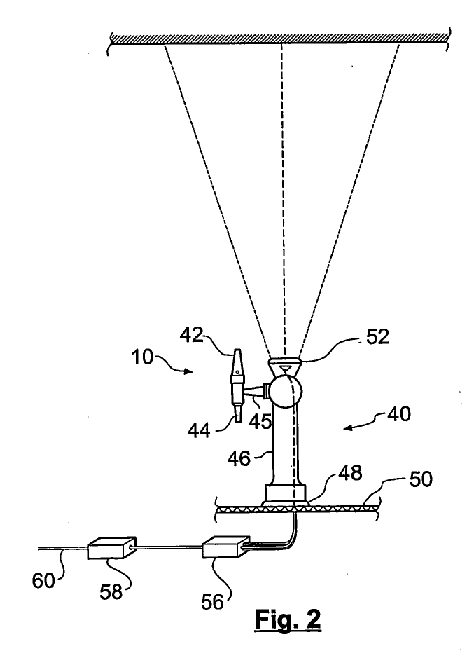

FIG. 2 shows schematically an alternative beverage dispensing device wherein the emitting device is located in the stanchion;

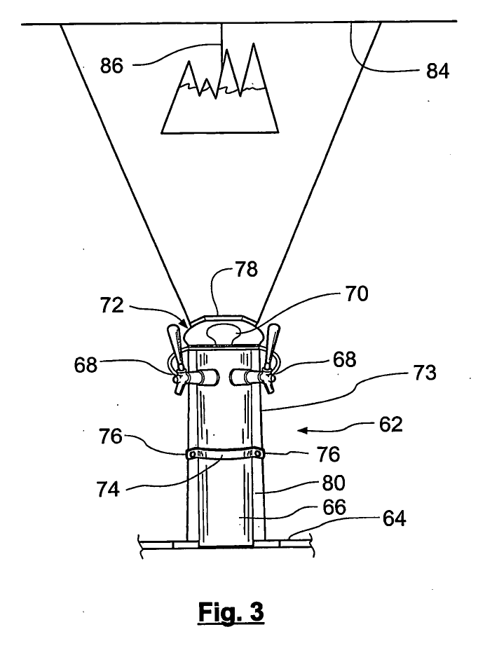

FIG. 3 shows a third dispensing device which includes two taps and the support stanchion is provided with a separate cover and a mobile is located directly above the assemblage.

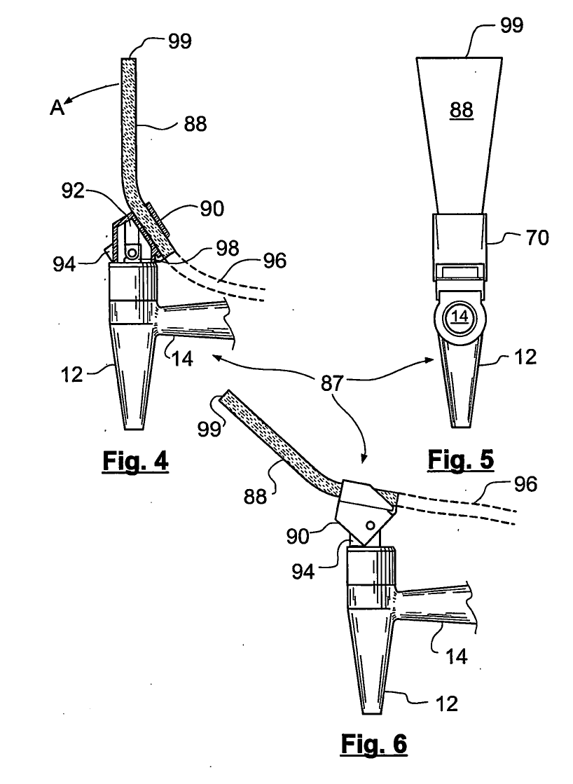

FIGS. 4, 5 and 6 shows an alternate to the device shown in FIG. 2 and wherein the dispensing tap handle comprises a light guide for projecting a light beam.

Referring to the FIG. 1, a dispensing tap device commonly called a “pump” generally designated 10 is of generally conventional form and comprises a nozzle 12 through which beer is dispensed, a conduit 14 connected to a supply of beer (e.g. a barrel) and a housing 13 which encloses a valve system (not shown) which opens or closes to control passage of the beer from the supply to the nozzle 12. A tap handle assembly shown generally at 14 operates the valve system in known manner. The handle assembly 14 is attached to the housing 13 by conventional means. A tap handle body 16 is pivotally attached to valve actuating member 18 such that as the handle body 16 is pulled in the direction of arrow A from a generally vertical towards a generally horizontal position until it is arrested by stop member 19. The actuator 18 acts upon the valve to open it and thereby allow passage of the beer through to the nozzle 12, and vice versa.

In this embodiment, tap handle body 16 is provided with light projection means comprising a light source, bulb 20, surrounded by reflector 24, and powered by a battery 25, a lens 26 forming the end of the handle body 16. The battery is preferably rechargeable to reduce operating costs. Moreover, for convenience, an electrical jack 28 can be provided to allow the battery to be connected to a main supply and be charged without being removed. Note that the bulb is located away from the flow of cold beer and hence has no opportunity to have any warming effect on it. In any event, the bulb is preferably of low power so as to reduce the heat generated during operation.

Alternatively, the bulb or alternative light source could be provided with electric power through jack 28 from an exterior source battery or electric mains and, if the latter, through a transformer if a low power bulb is used. Although such systems, which utilize wiring extending into the handle, can have problems associated, for example, with the need to accommodate the pivoting of the handle etc. the systems are well tried and proven in commercial use.

The outer surface of lens 26 can be unadorned and simply project the beam upwards or can be adapted to carry an assortment of displays for projection, such as logos; brand names; or other indicia. These may be permanently inscribed on the lens such as by etching or the like process for example, the brand name or a logo associated with the brand, can be permanently etched in the lens face. Alternatively, such indicia may be carried by interchangeable adhering transparent foils and changed periodically. In such cases, it may be desirable that the lens has a plain outer surface.

The handle assembly 14 is also provided with a switch (not shown) to turn the beam on and off as desired. It will be appreciated that the dispensing tap device 10 is carried by a stanchion (not shown) which is secured to a bar counter in a conventional manner. (refer FIGS. 2 and 3)

The above-described device and display system operates in a very simple manner and is essentially independent of the beer dispensing action of the tap arrangement. In this embodiment the beam is generally maintained active throughout the hours the tap dispenser is in use. When the handle is in the “off” position, the handle is located along a vertical axis—C-C—which includes the nozzle 12 and the light beam emitting through lens 26 is directed vertically and illuminates an area 30 on ceiling 32. During the beer dispensing action, the handle 26 is pulled manually by the operator in the direction of arrow A and the beam moves along the ceiling illuminating a swath of the ceiling until handle body 16 reaches the end of its movement as shown in FIG. 1. It should be noted that, with the handle body 16 in that position, the beam is angled approximately 30° from the vertical base position of the tap body 16. Taking into account the height of the lens, i.e. light emitting window, above the bar, the light beam is arranged not to cause any problems or inconvenience for the patrons or the staff.

Turing to FIG. 2, in this embodiment, the light beam emitter is located in the stanchion or tower 40 which carries the dispensing tap arrangement 10. The latter comprises a simple operating lever or small handle 42, nozzle 44 and delivery tube 45; beer being delivered to the latter via a conduit (not shown) located within the hollow stanchion body 46. Stanchion body 46 has a base 48 which is secured to bar counter 50 by any convenient means e.g. clamps. Located at the upper extremity of stanchion 40 is a light diffuser/projector 52. Light is delivered to projector 52 via a fiber optic cable 54 (shown in phantom) which extends up an interior wall of stanchion body 46 from a light box 56. Light box 56 is powered via a transformer 58 which derives its power via cable 60 which is connected to the usual electrical main power source (not shown). It may be noted that this specific light system produces “cold” light which is less likely to produce heat inside the stanchion and hence, warm the beer on its way to the dispensing tap also through the stanchion body 46.

The projector window 52 is, as shown flat and can readily accommodate adhering foils carrying the name and/or the logo of the brand of beer being dispensed through this dispensing system. Alternatively, if the projector is rigged to produce a wider, rather than narrower focused, beam, then it could be used to project a relatively large message e.g. a menu onto the ceiling immediately above. In this embodiment the beam is fixed and covers a total angle of about 40°, i.e. 20° from the vertical. It will be appreciated that the distance from the projector or window 52 to the ceiling decides, to some extent, along with the size of letters in the message, etc. the size of the wording on the ceiling.

FIG. 3 shows a further embodiment wherein a stanchion or tower 62 is secured by any convenient means to a bar counter 64. The stanchion body 66 carries two conventional dispensing taps 68. The arrangement whereby beer is provided to the dispensing taps is conventional (the conduits carrying the beer from storage tanks or kegs extend through stanchion body 66 etc.) and will not be described further.

The light emitting system in this case comprises a bulb 70 located in a light chamber 72 carried by stanchion cover 73 which cover is removably secured to stanchion body 66 via clamp 74 and screws 76. Light chamber 72 includes light transmitting window or screen 78. Stanchion cover 73 as can be seen, is open on the side facing the server (i.e. toward the reader) this allowing for circulation of air around the stanchion body and including the underneath of the light chamber 72. The bulb 70 is powered via an electrical cable 80 running down the inside wall of cover 73. The result of this arrangement is that any heat generated via the light production and emitting system is readily be removed by air circulation and does not present any problems with respect to ensuring that cooled beer arrives at the dispensing tap. Note also that light from the light chamber 72 is allowed to shine outwardly toward the dispense operation providing illumination to the operator's working surface etc.

Finally, in this embodiment, the beam is arranged to draw attention to a promotional mobile 82 suspended from the ceiling 84 via a string 86. The mobile is formed in the shape of mountains having snow depicted on the mountain peaks and it slowly rotates in response to air movement in the establishment.

In a further modification of this embodiment, suitable known electric current interruption means are provided to provide pulsed on/off effects and stroboscopic effects.

The above specific embodiments have been described with respect to visible beams. However, ultra violet and infra red beams could be used either alone or in combination with a light beam to provide flexibility in the provision of the presentations.

It is understood that preferred embodiments of the invention have been described above in order to illustrate how to make and use the invention. The invention is not intended to be limited to these embodiments, but rather is intended to be limited only by any claims which will be included in the full appreciation for a utility patent based on this application. Thus, the invention encompasses all alternate embodiments that fall literally or equivalently within the scope of those claims.

Turning to FIG. 4, this depicts an alternative dispensing tap assembly where the tap handle 88 is plastic and trapezoid in shape and functions as a light guide. Similar in operation to the tap handle arrangement shown in FIG. 1, this is adapted to easily replace the existing tap lever or handle. The handle 88 is carried by a simple rigid plastic housing 90 which has an integral lever 92 pivotably affixed to valve actuator 98. The tap handle therefore has a pivotal/camming action which moves the lever 92 to lift the valve actuate 98 to open a diaphragm valve (not shown) contained in the tap body below the handle 88. This is quite conventional. The housing 90 is also provided with stop member 94. The handle 88 is connected via light guide cable 96 to a suitable light source (not shown).

In operation, the base position—valve closed and as beverage flowing through conduit 14 to nozzle 12—the handle 88 is vertically oriented as shown in FIGS. 4 and 5.

To dispense beer, the handle 88 is rotated in the direction of arrow A in FIG. 4 and is permitted to rotate only a set amount by stop 94—refer to FIG. 6. This embodiment lends itself to projecting various customer information messages by applying suitable transparent plastic films to the “window” or lens 99 of handle 88.

1. A beverage dispensing assembly which includes light emitting means adapted to project a beam of light generally upwardly, which beam is adapted to communicate information to consumers.

2. An assembly according to claim 1 wherein said beam is adapted to impinge on screen means located thereabove.

3. An assembly according to claim 2 wherein said screen means is a ceiling.

4. An assembly according to claim 2 wherein said beam is adapted to pass through an information-containing member, which information is thereby displayed on said screen means.

5. An assembly according to claim 1 wherein said beam is adapted to move within the confines of a cone having a generally vertical axis and a cone angle of not more than about 60°.

6. An assembly according to claim 1 wherein said light is visible light.

7. An assembly according to claim 1 wherein said movement results in said beam successively traversing sequential elements of a message already located on said screen.

8. An assembly according to claim 4 wherein said information is indicative of a type or brand of beverage which the device is adapted to dispense.

9. A beverage dispensing assembly comprising in combination, a dispensing tap for dispensing a beverage, said tap having a handle and a tap opening and closing mechanism and being adapted to be attached to a counter, and light emitting means adapted to project a beam of light generally upwardly, which beam is adapted to communicate information to consumers and to contact information displaying surface thereabove.

10. An assembly according to claim 9 wherein said surface is screen means.

11. An assembly according to claim 10 wherein said beam carries information which is displaced on said screen.

12. An assembly according to claim 11 wherein said information is indicative of a type or brand of beverage which the device is adapted to dispense.

13. An assembly according to claim 10 wherein said beam is adapted to move within a vertically oriented cone having a cone angle of not more than about 60°.

14. An assembly according to claim 13 wherein movement of said handle cause said beam to move.

15. A promotional and beverage dispensing device comprising the combination of a dispensing assembly having a dispensing tap for dispensing a beverage, said tap having a handle and tap opening and closing means and being adapted to be carried by a support, and light emitting means adapted to project a beam of light generally upwardly, said beam being adapted to communicate information to consumers and information displaying means located thereabove adapted to receive said beam of light.

16. A device according to claim 15 wherein said beam is adapted to move but only within the confines of a cone having a generally vertical axis and a cone angle of not more than about 60°.

17. A device according to claim 15 wherein said beam is adapted to move in response to movement of said taps.

18. A device according to claim 15 wherein said information displaying means is a ceiling.

19. A device according to claim 15 wherein said information is indicative of a type or brand of beverage adapted to be dispensed by said device.

20. A method of promoting a beverage by visually importing information relating to said beverage via a device as claimed in claim 1, 9 or 15.
